(19) United States
(12) Patent Application Publication
(10) Pub. No.: US 2007/0170211 A1
(43) Pub. Date: Jul. 26, 2007

(54) Container and toner replenishing device using the same

(76) Inventor: Yoshio Hattori, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/932,038

(22) Filed: Sep. 2, 2004

(30) Foreign Application Priority Data
Sep. 4, 2003 (JP) 2003-312344 (JP)

(51) Int. Cl. G01F 11/00

(52) U.S. Cl. 222/325; 222/DIG. 1

(57) ABSTRACT

A cylindrical container of the present invention is configured to convey a liquid or powder stored therein in the axial direction and includes a body having an outlet formed in its end portion. A slide shutter is movable in the axial direction of the body for selectively opening or closing the outlet.

### BACKGROUND OF THE INVENTION

1. Field of the Invention

The present invention relates to a cylindrical container configured to convey a liquid or powder stored therein in the axial direction and more particularly to a toner replenishing device for an image forming apparatus using the same as a toner cartridge.

2. Description of the Background Art

Japanese Patent Laid-Open Publication No. 6-274028, for example, discloses a toner replenishing device for an electrophotographic copier, printer, facsimile apparatus or similar image forming apparatus. The toner replenishing device taught in this document is configured such that when the operator of the image forming apparatus simply inserts a toner bottle, the mouth of the toner bottle is automatically opened. When the toner bottle runs out of toner, the operator removes the toner bottle by rotating the toner bottle in the direction in which it rotates at the time of toner discharge, then rotating the toner bottle in the opposite direction, and then pulling out the toner bottle in the axial direction.

The configuration stated above minimizes the scattering of toner because the amount of operation for opening a cap attached to the mouth of the toner bottle is small and because the diameter of the mouth itself is small.

On the other hand, Japanese Patent Laid-Open Publication No. 59-188678, for example, proposes atoner replenishing device using a cylindrical toner container, e.g., a cartridge or a bottle formed with a guide rib or ridge on its inner surface. The above document teaches two different mechanisms for opening and closing the cartridge, i.e., a mechanism (1) including a stopper fitted in the mouth of the cartridge for hermetically closing the cartridge and a mechanical device arranged on the body of an image forming apparatus for opening and closing the stopper and a mechanism (2) including a cap positioned on the end of the cartridge and provided with a shutter member capable of engaging with the body. As for the mechanism (2), when the operator mounts or dismounts the cartridge to or from the body, the cap is rotated to open or close the shutter.

It is a common practice with both of the prior art toner replenishing devices described above to rotate, at the time of toner discharge, the toner cartridge or bottle by using torque available with the image forming apparatus and to use a coupling for torque transfer. Although the coupling may, of course, be replaced with a gear formed on the inner surface of the toner cartridge, torque transfer using a gear is extremely difficult to lay out in consideration of, e.g., the arrangement and drive transmission of a developing unit, a photoconductive element, an image transferring device and a fixing unit included in an image forming apparatus whose size is decreasing.

In any case, when a coupling is used to connect the drive section of the image forming apparatus and the toner cartridge or bottle, torque is transferred to the end of the cartridge opposite to the mouth. This is because the mouth included in the mechanism (1) is positioned at one end of the toner cartridge and because the cap included in the mechanism (2) does not rotate and is therefore positioned at the side opposite to the coupling. Further, the drive section of the image forming apparatus is usually positioned at the side opposite to the operator in order to facilitate operation and reduce noise. For these reasons, the toner cartridge is provided with a coupling portion and a mouth at the rear end and front end, respectively, as seen from the operator's side.

However, the above configuration of the toner cartridge or container has a problem that when the operator replaces the cartridge, toner is apt to fly about via the mouth of the cartridge adjoining the operator and smear the operator's clothes. While the diameter of the mouth may be made as small as possible in order to prevent the toner from flying about, such a scheme brings about another problem that toner blocking or defective toner replenishment occurs due to the deterioration of the toner, i.e., the fall of fluidity. Therefore, the mouth of the toner cartridge should be provided with a certain diameter. It follows that the toner cartridge should preferably be configured such that the mouth is located at the rear side of the image forming apparatus.

### SUMMARY OF THE INVENTION

It is an object of the present invention to provide a toner container having a coupling configuration or torque transfer portion and a mouth or toner outlet located at the same side thereof and a toner replenishing device for an image forming apparatus using the same.

In accordance with the present invention, a cylindrical container is configured to convey a liquid or powder stored therein in the axial direction and includes a body having an outlet formed in its end portion. A slide shutter is movable in the axial direction of the body for selectively opening or closing the outlet.

A toner replenishing device for an image forming apparatus using the above container is also disclosed.

### BRIEF DESCRIPTION OF THE DRAWINGS

The above and other objects, features and advantages of the present invention will become more apparent from the following detailed description taken with the accompanying drawings in which:

FIG. 1 is a fragmentary section showing a container embodying the present invention and implemented as a toner cartridge; and

FIG. 2 is a perspective view of the toner cartridge.

### DESCRIPTION OF THE PREFERRED EMBODIMENT

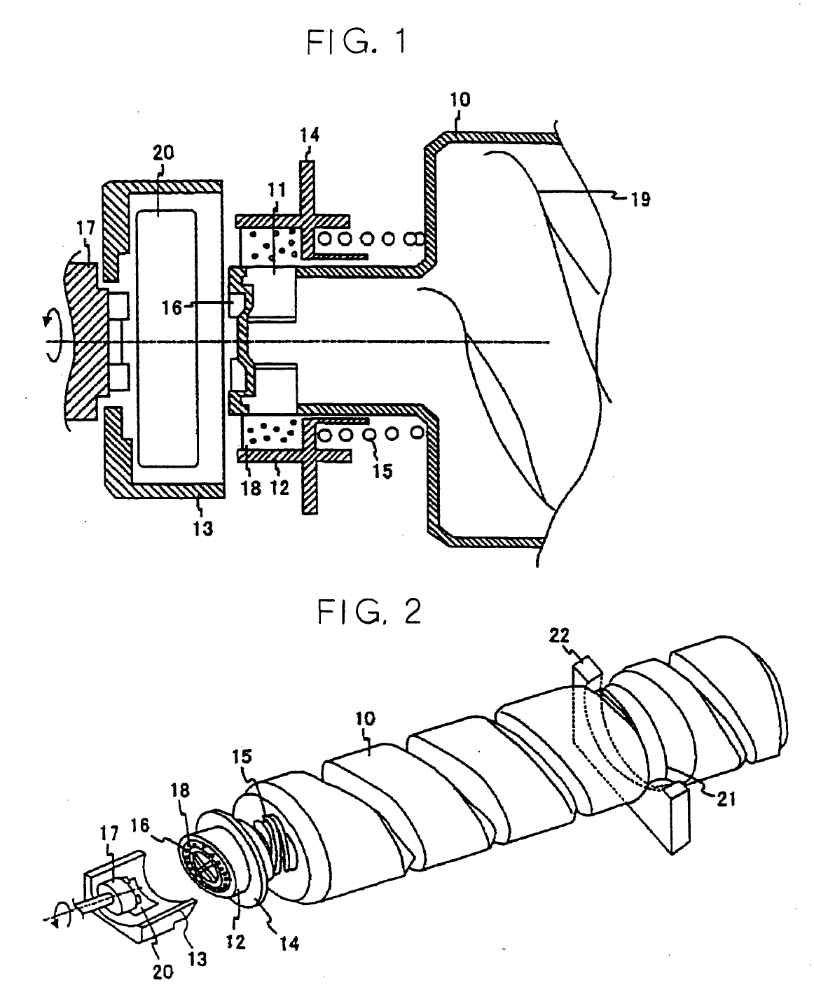

Referring to FIGS. 1 and 2, a container embodying the present invention is shown and implemented as a toner cartridge. As shown, the toner cartridge includes a cartridge body 10 provided with a unique end portion to be described hereinafter. The end portion includes a toner outlet or mouth 11 surrounding a hollow cylindrical portion having a small diameter. A slide shutter 12 is slidable in the axial direction of the above cylindrical portion for selectively opening or closing the toner outlet 11. An abutment 14 is configured to move the slide shutter 12 on abutting against an abutment 14 included in the body of an image forming apparatus (apparatus body hereinafter). A spring 15 constantly biases the slide shutter 12 to a position where the slide shutter 12 closes the toner outlet 11.

In the illustrative embodiment, the movement of the slide shutter 12 is based on balance between a force to be exerted by the abutment 13 of the apparatus body on the abutment 14 of the cartridge body 10 and the bias of the spring 15. This makes it unnecessary to rotate the toner cartridge by hand and therefore allows it to be extremely easily handled.

The illustrative embodiment further includes a coupling configuration 16 positioned at the end of the cartridge body 10 such that torque can be transferred from the apparatus body to the coupling configuration 16 via a drive shaft 17.

In the condition shown in FIG. 1, the slide shutter 12 protrudes forward under the action of the spring 15 to thereby close the toner outlet 11 with its inner surface. On the other hand, when the cartridge body 10 is mounted to the apparatus body, the abutment 14 of the former abuts against the abutment 13 of the latter and is pressed thereby against the action of the spring 15, causing the slide shutter 12 to move backward and open the toner outlet 11.

A soft seal member 18 is positioned radially inward of the slide shutter 12 in order to seal the toner outlet 11 and may advantageously be formed of single-cell sponge, felt or rubber.

In the above configuration, when the cartridge body 10 is mounted to the apparatus body, the toner outlet 11 is opened and communicated to a toner inlet 20 formed radially inward of the abutment 13 of the apparatus body. As a result, toner stored in the cartridge body 10 is replenished to the apparatus body.

If desired, the coupling configuration 16 of the cartridge body 10 may be positioned on the portion of the slide shutter 12 expected to engage with the apparatus body, i.e., the end face of the small diameter, hollow cylindrical portion. In such a case, the slide shutter 12 and cartridge body 10 should be provided with an engaging portion for regulating movement in the direction of rotation.

While the cartridge body 10 is formed with a spiral rib or ridge 19 on its inner surface, the present invention is, of course, applicable to any kind of container so long as it has a cylindrical configuration and rotates by being driven from the outside.

The apparatus body includes, in addition to the toner inlet 20, a replenishing path, a screw and so forth extending to an image forming section, although not shown specifically. The screw conveys the toner received from the cartridge body 10 via the toner inlet 20 to the image forming section in response to a control signal generated in the apparatus body.

When the cartridge body 10 is mounted to the apparatus body, a member, not shown, included in the apparatus body and positioned at the side opposite to the coupling retains the axis of the cartridge body 10. In addition, as shown in FIG. 2, a support member 22 also included in the apparatus body supports a reduced-diameter portion 21 formed in the outer periphery of the cartridge body 10. In this condition, the cartridge body 10 is stably held on the apparatus body.

In summary, it will be seen that the present invention provides a container or toner cartridge extremely easy to handle and preventing toner stored therein from flying about and smearing the operator's clothes.

Various modifications will become possible for those skilled in the art after receiving the teachings of the present disclosure without departing from the scope thereof.

What is claimed is:

1. A cylindrical container configured to convey a liquid or a powder stored therein in an axial direction, comprising:
a body;
an outlet formed in an end portion of said body; and
a slide shutter movable in an axial direction of said body for selectively opening or closing said outlet.

2. The container as claimed in claim 1, wherein said slide shutter is moved by a spring.

3. The container as claimed in claim 1, wherein said container comprises a toner cartridge for use in an image forming apparatus.

4. In a toner replenishing device for an image forming apparatus that uses as a toner cartridge a cylindrical container configured to convey a liquid or a powder stored therein in an axial direction, said container comprising:
a body;
an outlet formed in an end portion of said body; and
a slide shutter movable in an axial direction of said body for selectively opening or closing said outlet;
wherein when said toner cartridge is mounted to the image forming apparatus, said slide shutter is opened to provide communication between said outlet and an inlet of said image forming apparatus, whereby toner is replenished to said image forming apparatus when said body is rotated, and
when said toner cartridge is dismounted from the image forming apparatus, said slide shutter is closed.

5. The device as claimed in claim 4, wherein the image forming apparatus includes a drive section for rotating said body, and
a torque is transmitted from the image forming apparatus to said body by a coupling.
